(19) United States
(12) Patent Application Publication
(10) Pub. No.: US 2026/0187555 A1
(43) Pub. Date: Jul. 2, 2026

(54) ENHANCED USER INTEFACES AND ACTIONABLE RESOURCE MANAGEMENT ACTIONS USING INTEGRATED DATA SOURCES

(71) Applicant: Wells Fargo Bank, N.A., San Francisco, CA (US)

(72) Inventor: Frank J. Fehrenbach, Millburn, NJ (US)

(21) Appl. No.: 19/007,522

(22) Filed: Jan. 1, 2025

(51) Int. Cl. G06Q 10/0631; G06Q 10/0639; G06Q 30/0202; G06Q 30/0204

(52) U.S. Cl. CPC G06Q 10/06315; G06Q 10/06393; G06Q 30/0202; G06Q 30/0205

(57) ABSTRACT

A computer-implemented method integrates payment card data into a financial treasury management system. The method involves receiving payment card transaction data tagged with merchant category codes and filtering it based on the organization's category. Financial data such as sales, location, and cash flow is also acquired. Using this data, a resource optimization recommendation is generated and automatically provisioned by transmitting a command to a server. Additional features include receiving demographic data, calculating performance benchmarks, generating predictive indicators, and providing resource discounts or lending products based on the integrated data. Alert indicators are generated when transaction data deviates from expected patterns, prompting organizations to address potential issues.

### TECHNICAL FIELD

Embodiments pertain to information processing systems. Some embodiments relate to the integration of payment card transaction data into treasury management platforms to provide enhanced insights, predictive capabilities, and actionable recommendations.

### BACKGROUND

Treasury management systems (TMS) are tools used by organizations to manage their financial operations, including cash flow, liquidity, investments, and risk management. These systems provide a centralized platform for monitoring and controlling financial activities, ensuring that organizations can efficiently manage their resources and make informed financial decisions. Traditionally, treasury management systems have focused on core functionalities such as cash management, payment processing, and financial reporting. These systems enable organizations to track their cash positions, forecast future cash flows, and optimize their liquidity. By automating routine financial tasks, TMS helps reduce manual errors, improve accuracy, and enhance operational efficiency.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a system for integrating payment card data into a treasury management system according to some examples of the present disclosure.

FIG. 2 illustrates a block diagram of a treasury management system including data acquisition gatherers, indicator management components, and action generation components according to some examples of the present disclosure.

FIG. 3 illustrates a flowchart of a method for utilizing payment card data in a treasury management system according to some examples of the present disclosure.

FIG. 4 illustrates a graphical user interface (GUI) of a treasury management system providing insights derived from payment card data according to some examples of the present disclosure.

FIG. 5 illustrates a block diagram of an example machine upon which any one or more of the techniques discussed herein may be performed.

### DETAILED DESCRIPTION

Traditional treasury management systems (TMSs) are designed to handle core financial operations such as cash management, payment processing, and financial reporting. While these systems are effective in managing internal financial data, they often lack integration with external data sources such as payment card data. The inventors have recognized that lack of access to external data such creates a number of technical problems for TMSs.

First, without access to external data such as payment card data, TMSs cannot provide a comprehensive view of an organization's financial health. Payment card transactions have become a significant portion of consumer spending, and excluding this data results in an incomplete financial picture. Organizations miss out on valuable data that provides information about consumer behavior, spending patterns, and market trends.

Second, in the absence of integrated payment card data, organizations often rely on manual processes to collect and reconcile transaction data from disparate sources. This approach is time-consuming, error-prone, and leads to delays in decision-making. The lack of automation hinders the efficiency and accuracy of financial operations.

Third, payment card data provides real-time insights into consumer behavior, which is used for predictive analytics. Without this data, TMS forecasts regarding future sales, cash flows, or potential financial risks are less accurate. As a result, organizations may make data-driven decisions to optimize their financial strategies and mitigate risks using incomplete data.

Fourth, without this data, organizations may struggle to identify and reach specific customer segments, resulting in less effective marketing campaigns and financial offerings. The inability to tailor strategies based on consumer behavior limits the organization's competitive edge.

Finally, payment card data allows organizations to benchmark their performance against industry peers and competitors. Without this data, TMS cannot provide meaningful performance comparisons, making it difficult for organizations to assess their market position and identify areas for improvement. The lack of benchmarking hinders strategic planning and performance optimization. Finally, payment card data can reveal trends and patterns that help organizations optimize their resources, such as inventory management, staffing, and promotional activities. Without this data, TMS cannot generate actionable recommendations for resource optimization, leading to inefficiencies and missed opportunities for cost savings and revenue growth.

In summary, the lack of payment card data integration in traditional treasury management systems limits the ability of organizations to gain comprehensive financial insights, automate processes, predict future trends, develop effective strategies, benchmark performance, and optimize resources. Integrating payment card data into TMS can address these challenges and unlock significant value for organizations.

Disclosed in some examples are methods, systems, devices, and machine-readable mediums for integrating payment card data into financial treasury management systems to provide comprehensive financial insights, automate processes, predict future trends, develop effective strategies, benchmark performance, and optimize resources. The invention achieves these benefits by obtaining payment card transaction data, organizational financial data, and demographic data (e.g., age, gender, and the like of customers), and then using that data to generate indicators such as performance benchmarks, predictive metrics, and alerts based on the integrated data. In addition, the data may be used to create one or more resource optimization recommendations that may be automatically enabled or enabled after approval from a user. Example resource optimization recommendations may include payment card discount offers, resource loans, and the like. This integration allows organizations to utilize real-time consumer behavior insights, automate data collection and reconciliation, and develop targeted marketing and financial strategies, thereby enhancing their overall financial management capabilities.

The technical problem addressed by the invention is the lack of integration of payment card transaction data into traditional treasury management systems (TMS). This deficiency results in incomplete financial insights, manual data collection and reconciliation, limited predictive capabilities, ineffective marketing and financial strategies, lack of benchmarking and performance analysis, and missed opportunities for resource optimization. Traditional TMSs are unable to provide a comprehensive view of an organization's financial health, automate processes, accurately forecast future trends, or develop targeted strategies due to the absence of real-time consumer spending data.

The technical solution provided by the invention involves integrating payment card transaction data into the financial treasury management system. This integration allows the TMS to receive and process payment card transaction data tagged with specific merchant category codes, along with the organization's financial data such as sales, location, and cash flow. By automatically correlating these data sets, the system can generate resource optimization recommendations, indicators (such as performance benchmarks, predictive metrics), and alerts. The solution allows for real-time decision-making processes and enhances the efficiency and accuracy of financial operations, provides real-time insights into consumer behavior, and enables the development of targeted resource optimization strategies, ultimately improving the organization's competitive edge and operational effectiveness. In some examples, this may be accomplished through user settings and rules which may automatically provide one or more alerts, take one or more resource optimization actions, and the like.

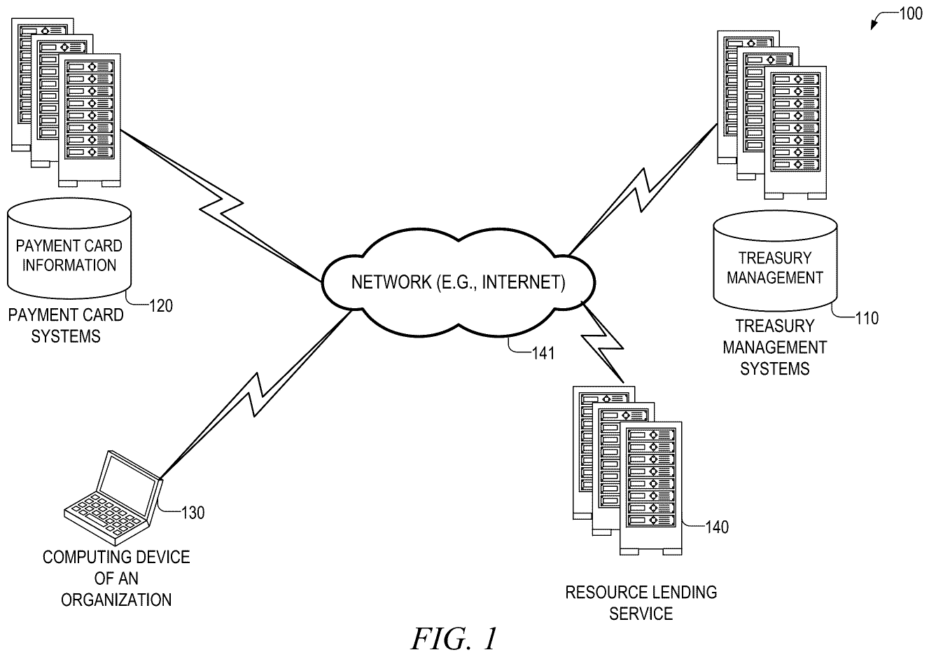

FIG. 1 illustrates a system 100 payment card data integration into a treasury management system 110 according to some examples of the present disclosure. Payment card systems 120 which process transactions from payment cards, such as credit cards, debit cards, and other cards, may provide payment card data such as transaction amount, date, time, merchant code, information on which products were purchased and the like to the treasury management systems 110. In some examples, the data may be anonymized to protect consumer personal identifiable information. In some examples, the components may communicate over a computer network 141.

The treasury management systems 110 may utilize this data, along with customer demographic information and information about an organization, to provide a plurality of indicators. For example, the payment card data, demographic data, and data about the organization may be used as input to a set of one or more hierarchical rules. The output of the rules may be one or more indicators that may be presented to a user, such as through a UI provided by the treasury management systems 110. The output of the rules may be prioritized within the UI based upon prioritization rules. The prioritization rules may take the indicators as input and output a ranking of the indicators. Indicators that rank above a certain threshold or percentage may be displayed to a user associated with an organization. For example, the user may be utilizing a computing device associated with an organization 130. Rules may be prespecified or may be configured by the user of the computing device of the organization 130. Rules may be if-then rules that evaluate one or more payment card data, demographic data, and/or data about the organization.

Example indicators encompass a variety of analytics, metrics, and insights derived from the integration of payment card transaction data with organizational financial data. These indicators include performance benchmarks, which compare an organization's transaction data with that of its peers within the same merchant category code, providing a relative performance measure. Predictive indicators forecast future sales based on historical transaction data and current financial metrics, enabling organizations to anticipate and plan for future financial conditions. Additionally, demographic indicators analyze transaction data by age, gender, and income level of cardholders, offering insights into customer segments. Geographic indicators break down transaction data by city, state, and zip code, allowing for location-specific analysis. Alert indicators may be generated when data deviates from expected patterns beyond a predefined threshold, prompting organizations to investigate and address potential issues. Example indicators may be an average transaction value, an average transaction value compared to other merchants with a same merchant code, average transaction value compared to other merchants with a same merchant code and location, card transaction data broken down by location, sales performance by month, gender-based breakdowns of payment card data, a sales ranking for a particular period of time, a peer ranking per market segment, and the like.

In addition, based upon the one or more indicators produced, the system may utilize one or more action rules to implement and/or suggest one or more resource-related actions. For example, if the indicators indicate, that according to recent payment card data and recent organizational resource-flow (e.g., cash flow) data, that the organization may be low on resources during a specific time window, the system may generate a recommendation that the organization obtain additional resources, such as by borrowing money, to get the organization through the period. In some examples, the treasury management system 110 may communicate with a resource lending service 140. The treasury management system 110 may communicate organizational data to the resource lending service 140 and the organization may automatically get qualified for a loan. In these examples, the user of the organization may have to simply click a button on the UI to obtain the funds. In other examples, the loan may be automatically obtained based upon one or more rules setup in advance. In still other examples, the organization may automatically receive a loan application.

In some examples, other resource-related actions may include providing payment card transaction discounts to customers. These payment card transaction discounts may be communicated to the payment card systems 120 where they may be automatically applied to consumers. In some examples, the consumers may be provided one or more notifications on their personal devices or through email of the promotion. In some examples, the transaction discounts may be specific to a particular consumer demographic, location, branch location, product type, or the like.

In still other examples, other resource-related actions may include providing automated alerts that are sent to computing devices of the organization 130. These alerts may be generated using one or more rules. The alerts may be sent through the computer network 141 to the computing device of the organization 130. In some examples, based upon one or more previously set preferences of the user, the alert may cause the computing device of the organization 130 to launch a treasury management application or page which displays the alert. For example, the alert may enable connection via a URL to the TMS.

By providing one or more resource-related actions, the present disclosure addresses the challenges of alerting companies with time-sensitive information, providing competitive resource-related strategies, and the like even when the companies are offline. This is done using communication channels that activate the competitive resource-related strategies automatically; or alert the computing device based upon stored rules and/or preferences.

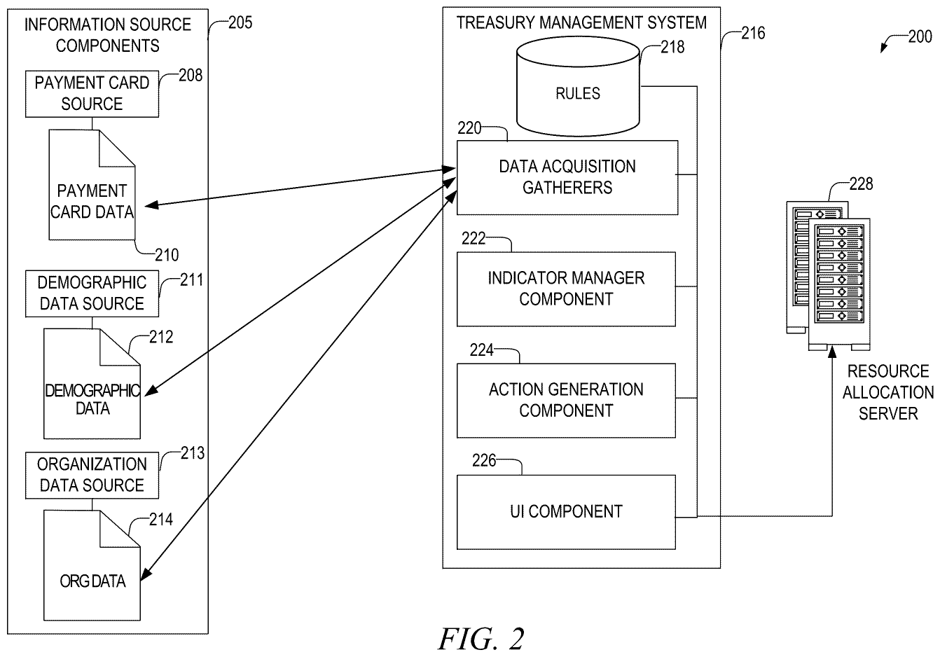

FIG. 2 illustrates a treasury management system 200 according to some examples of the present disclosure. TMS 216 may include one or more data acquisition gatherers 220 which may communicate with one or more information source components 205. Information source components 205 may be internal or external to the TMS 216. The information source components 205 may be located at, or may contact, one or more data sources to obtain data. For example, the payment card source component 208 may be a part of, or contact, one or more payment card systems such as payment card system 120 to obtain payment card data 210. Likewise, the demographic data source component 211 may be a part of, or contact, one or more demographic data source systems to obtain demographic data 212. In some examples, some or all of demographic data 212 may be part of the payment card data 210 or may be separate. In some examples, the demographic data source component 211 may be a payment card system 120 or treasury management system 216. In other examples, the demographic data source component 211 may be, or may contact, one or more external sources of demographic data. Demographic data 212 may be demographic data of one or more payment card users. The demographic data may be organized according to one or more merchant category ids to allow for correlation of demographic records based upon merchant category. In some examples, one or more of the information source components 205 may communicate with the treasury management system 216 over a network.

The organization data source component 213 may be a part of, or contact, one or more organization data source systems to obtain organization data 214. The organization data may relate to organizations that have accounts on TMS 216, and/or other organizations that may not have accounts on TMS 216 but may be competitors of organizations that have accounts on TMS 216. In some examples, some or all of organization data 214 may be part of the payment card data 210 or may be separate. In some examples, the organization data source component 213 may be a payment card system 120 or treasury management system 216. In other examples, the organization data source component 213 may be, or may contact, one or more external sources of organizational data. Example sources of organizational data include Securities and Exchange Commission (SEC) reports, company websites, and the like.

In some examples, the information source components 205 may be one or more API processes on internal or external systems such as the payment card systems 120 or TMS 216. Payment card systems and treasury management system 216 may be provided by same or different financial institutions.

In some examples, the data acquisition gatherers 220 may utilize one or more application programming interfaces (APIs) of the information source components 205 to acquire the payment card data 210, demographic data 212, and organization data 214. The demographic data 212 may be demographic data corresponding to the payment card data 210 and may also be obtained from the payment card system. In some examples, the demographic data 212 may be from data stored by the treasury management system 216, e.g., from cash, internet, or other sales. In some examples, this demographic data may be both from payment card systems and from the treasury management system 216. In other examples, the demographic data 212 may be from third party systems. Organization data may include cash flow information, sales information, bank account information, merchant code information, location data, and other data about an organization.

In some examples, the data acquisition gatherers 220 may be multiple instances that execute in parallel to obtain real-time or near-real time data from the information source components 205. This allows for continuous acquisition of live data from the information source components 205 and continuous indicator generation without slowing down the TMS 216.

The data collected by the data acquisition gatherers 220 may be processed by the indicator management component 222 to produce and manage indicators. For example, by applying one or more items of data collected by the data acquisition gatherers 220 to one or more rules stored in rule storage 218. In some examples, issued indicators may be retracted, or modified, based upon updated data from the data acquisition gatherers 220.

Rules may be mathematical formulas, if-then-else statements, decision trees, random forests, and the like. In still other examples, the rules in rule storage 218 may be in the form of one or more machine-learning models. For example, a neural network trained (e.g., using a backpropagation algorithm) on historical payment card, demographic, and/or organizational data that are labeled with one or more indicators. The model is then stored as a series of weights and/or biases. The payment card data 210, demographic data 212, and organization data 214 may then be fed to a neural network which may weigh each item of data at each layer of the neural network according to the rules stored in rule storage 218 to produce the indicators.

Action generation component 224 may utilize the indicators from indicator management component 222 to produce one or more resource-related actions. For example, the action generation component 224 may apply one or more other rulesets to determine, from the indicators, which resource-based actions to take and/or suggest to the user. As stated above, the rules may be stored in rule storage 218 and may be in the form of if-then-else rules, decision trees, random forests, or machine-learning models. For example, in the form of weights and/or biases of a neural network that is trained (e.g., using backpropagation) on past indicators labeled with desired actions. The indicators are then used as input to the rules to produce one or more actions. The model used to generate actions may be a same or different model used to generate the indicators.

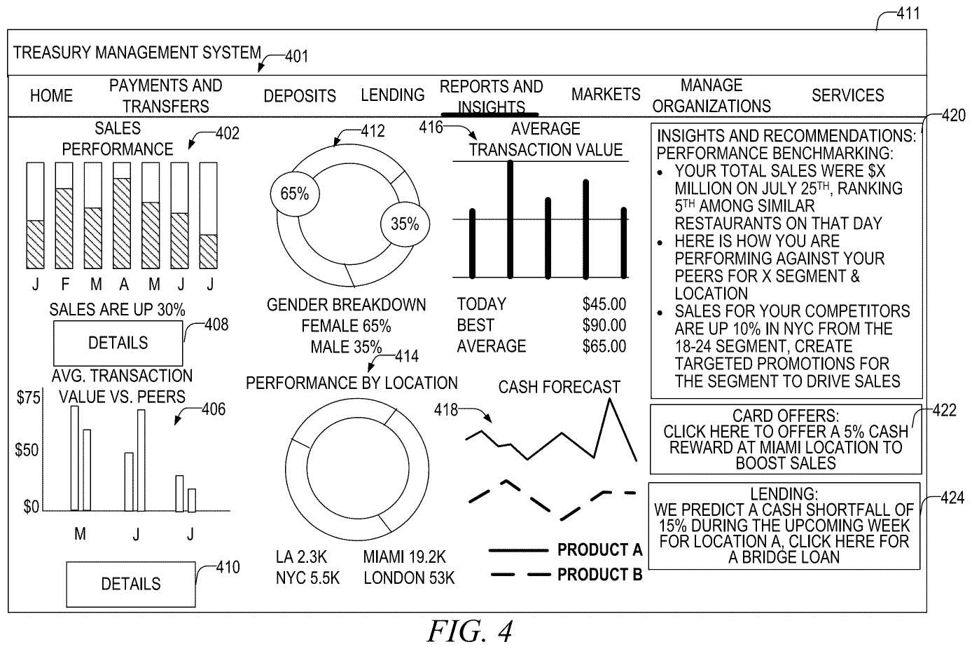

UI component 226 may provide one or more user interfaces, such as graphical user interfaces as part of the treasury management system. For example, a UI such as shown in FIG. 4. The UI may provide one or more indicators, resource action recommendations, or the like. In some examples, the indicators may be ranked or prioritized within the UI using one or more rules stored in the rule storage 218. The rules may be different depending on the client device. If the client device is a mobile device with a smaller screen, in order to prioritize limited information, the UI may provide only certain indicators. In other examples, with larger screens, the system may provide additional indicators.

In some examples, the actions determined by the action generation component 224 may be automatically performed. For example, one or more user settings entered through a UI component 226, or one or more other sets of rules from rule storage 218 may cause performance of a resource-related action without user input. In other examples, the actions are presented in a UI and the user may select to take the action. Upon selection to take the action, the action generation component 224 effectuates the action. For example, by communicating with a payment card service, a resource allocation server 228 (e.g., for borrowing money, transferring funds), or the like. In some examples rule storage 218 may be a database.

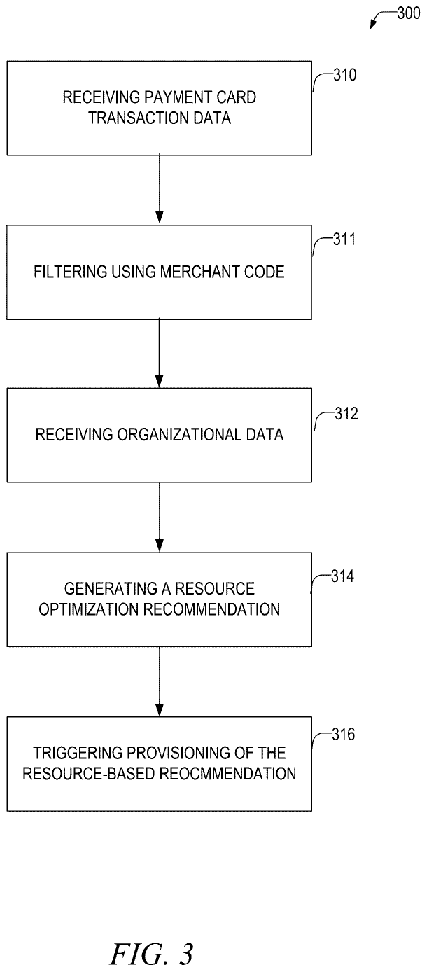

FIG. 3 illustrates a flowchart of a method 300 of utilizing payment card data in a treasury management system according to some examples of the present disclosure. At operation 310, the TMS receives payment card transaction data. For example, by contacting a payment card server. In some examples, the payment card server may be setup to push the payment card data to the TMS, but in other examples the payment card server may be polled by the TMS for the payment card data. The payment card data may be anonymized to protect payment card data customer privacy.

At operation 311, the system filters the payment card transaction data by the merchant category code (MCC) to filter out transactions that do not involve the same type of merchant as the customer for whom the resource-based recommendation is being prepared. For example, the resource-based recommendation may be prepared for a merchant categorized under a first category code. The filtering step will remove all payment card transaction data not belonging to the first category code. This step allows for generating insights and recommendations for the specific needs of the organization. The payment card transaction data, which includes details such as transaction amount, date, time, and location, is initially tagged with MCCs that categorize the type of merchant involved in each transaction. By filtering this data based on the organization's MCC, the system isolates transactions that are directly pertinent to the organization's industry or business type.

At operation 312, the TMS system may identify or receive organizational data, e.g., financial information about an organization. This organizational data may be obtained, e.g., through an Application Programming Interface (API)—such as by contacting a server over a network or obtaining organizational data from a database. Example data may include bank account data, sales data, cash flow data, contracts, location data, and the like. In some examples, the TMS system may also receive demographic data. At operation 314 the system may generate a resource optimization recommendation. For example, a payment card discount offer, a loan, and the like. As previously noted, these can be generated based upon one or more rules. In some examples, this may be generated using a machine learning model, such as a neural network, a Large Language Model (LLM) or the like. Alternatively, or in addition to generating the resource optimization recommendation, one or more indicators may be generated based upon the data.

At operation 316 the system may trigger the provisioning of the resource-based recommendation. For example, the TMS may command one or more services and/or systems to transfer funds from one account to another, obtain a loan, provide a payment card offer, or the like. These commands may be based upon an API. In some examples, this operation may be responsive to a user selection of a UI element to perform the action, but in other examples it may be responsive to a rule indicating that the action is to be taken automatically without user involvement.

FIG. 4 illustrates a GUI 411 of a TMS providing insights derived from payment card data according to some examples of the present disclosure. In some examples, the GUI may be generated by the TMS and sent to the computing device of the organization where it is displayed. A tab bar 401 provides various screens, such as a home screen, payments and transfers screen, deposits, lending, reports and insights, markets, manage organizations screen, and a services screen. The dark underlined reports and insights option has been selected and this is the screen displayed. The screen includes a sales performance graph 402 which shows sales broken down by month and an indicator that sales are up 30%. A button 408 allows users to obtain additional detail of sales performance. The screen includes a graph showing average transaction values vs those of the organization's peers 406 along with a button 410 that provides additional details. The screen shows a gender breakdown 412 of the organization's customers and a breakdown of the performance of each location 414. Further included is a graph showing average transaction value 416 and a cash forecast 418 for various products of the organization. At the right-hand side, various indicators called “insights and recommendations” are shown in a box 420. The screen also shows resource-based actions 422 and 424 in the form of card offers and lending.

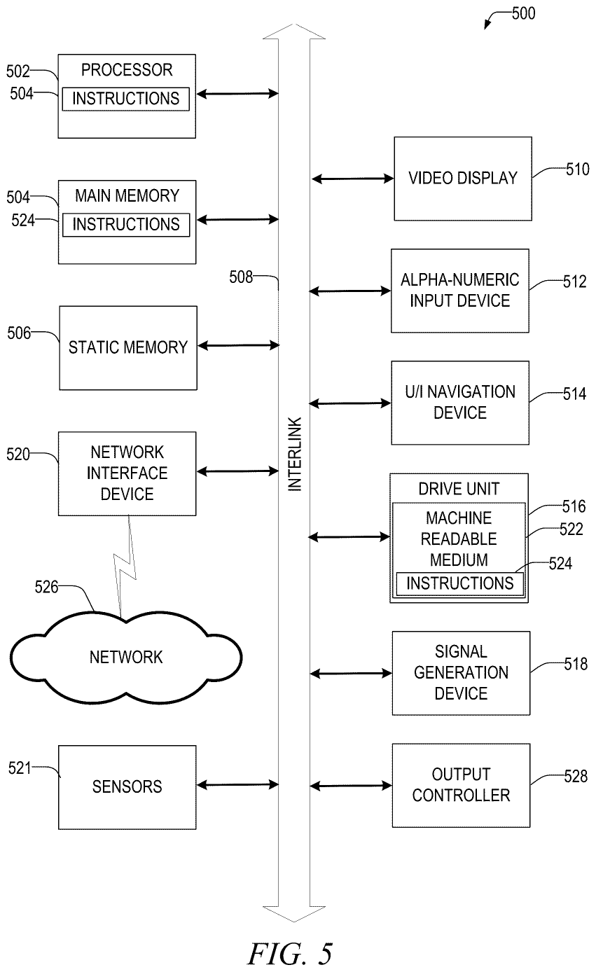

FIG. 5 illustrates a block diagram of an example machine 500 upon which any one or more of the techniques (e.g., methodologies) discussed herein may be performed. In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be in the form of a server, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations. Machine 500 may be configured to implement, or a part of the implementation of the computing device of an organization 130, payment card systems 120, treasury management systems 110, resource lending service 140, information source components 205, treasury management system 216, resource allocation server 228. Machine 500 may implement the method of FIG. 3, and the GUI of FIG. 4.

Examples, as described herein, may include, or may operate on one or more logic units, components, or mechanisms (hereinafter “components”). Components are tangible entities (e.g., hardware) capable of performing specified operations and may be configured or arranged in a certain manner. In an example, circuits may be arranged (e.g., internally or with respect to external entities such as other circuits) in a specified manner as a component. In an example, the whole or part of one or more computer systems (e.g., a standalone, client or server computer system) or one or more hardware processors may be configured by firmware or software (e.g., instructions, an application portion, or an application) as a component that operates to perform specified operations. In an example, the software may reside on a machine readable medium. In an example, the software, when executed by the underlying hardware of the component, causes the hardware to perform the specified operations of the component.

Accordingly, the term “component” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which component are temporarily configured, each of the components need not be instantiated at any one moment in time. For example, where the components comprise a general-purpose hardware processor configured using software, the general-purpose hardware processor may be configured as respective different components at different times. Software may accordingly configure a hardware processor, for example, to constitute a particular module at one instance of time and to constitute a different component at a different instance of time.

Machine (e.g., computer system) 500 may include one or more hardware processors, such as processor 502. Processor 502 may be a central processing unit (CPU), a graphics processing unit (GPU), a hardware processor core, or any combination thereof. Machine 500 may include a main memory 504 and a static memory 506, some or all of which may communicate with each other via an interlink (e.g., bus) 508. Examples of main memory 504 may include Synchronous Dynamic Random-Access Memory (SDRAM), such as Double Data Rate memory, such as DDR4 or DDR5. Interlink 508 may be one or more different types of interlinks such that one or more components may be connected using a first type of interlink and one or more components may be connected using a second type of interlink. Example interlinks may include a memory bus, a peripheral component interconnect (PCI), a peripheral component interconnect express (PCIe) bus, a universal serial bus (USB), or the like.

The machine 500 may further include a display unit 510, an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 516 may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 524 may further be transmitted or received over a communications network 526 using a transmission medium via the network interface device 520. The Machine 500 may communicate with one or more other machines wired or wirelessly utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks such as an Institute of Electrical and Electronics Engineers (IEEE) 802.11 family of standards known as Wi-Fi®, an IEEE 802.15.4 family of standards, a 5G New Radio (NR) family of standards, a Long Term Evolution (LTE) family of standards, a Universal Mobile Telecommunications System (UMTS) family of standards, peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. In some examples, the network interface device 520 may wirelessly communicate using Multiple User MIMO techniques.

### Other Notes and Examples

Example 1 is a computer-implemented method for integrating payment card data into a financial treasury management system of an organization, the method comprising, at the financial treasury management system: executing one or more data acquisition gatherers to cause receipt of payment card transaction data from one or more external information source components, the payment card transaction data describing a plurality of payment card transactions and tagged with a merchant category code, wherein the payment card transaction data includes, transaction amount, transaction date, transaction time, and location for each transaction described by the payment card transaction data occurred; filtering, at an indicator manager component, the payment card transaction data using the merchant category code tags based upon a merchant category code of the organization; executing second one or more data acquisition gatherers to cause receipt of financial data of the organization from the one or more information source components, the financial data including sales data, location data, and cashflow data; generating a resource optimization recommendation based upon the filtered payment card transaction data and the financial data of the organization as input to a recommendation rule; and responsive to generating the resource optimization recommendation, automatically triggering provisioning of the resource optimization recommendation by transmitting a command to a server over a network.

In Example 2, the subject matter of Example 1 includes, receiving demographic data associated with the payment card transactions, the demographic data including one or more of age, gender, and income level of cardholders.

In Example 3, the subject matter of Examples 1-2 includes, calculating a performance benchmark indicator for the organization by comparing the payment card transaction data with transaction data from other organizations within a same merchant category code; and displaying the performance benchmark indicator to the organization in a UI generated by the financial treasury management system.

In Example 4, the subject matter of Examples 1-3 includes, generating a predictive indicator describing predicted future sales based on a rule, historical payment card transaction data, and the financial data of the organization.

In Example 5, the subject matter of Examples 1-4 includes, receiving geographic data associated with the payment card transactions, the geographic data including one or more of city, state, and zip code of transaction locations.

In Example 6, the subject matter of Examples 1-5 includes, wherein the resource optimization recommendation is a resource discount provided by the organization, the resource optimization recommendation targeted to one or more of a specific demographic, a specific time, a specific product, or a specific location.

In Example 7, the subject matter of Examples 1-6 includes, generating alert indicators for the organization when the payment card transaction data indicates a deviation from expected sales patterns that exceeds a threshold.

In Example 8, the subject matter of Examples 1-7 includes, wherein the resource optimization recommendation is providing a resource lending product based on predicted resource shortages derived from the payment card transaction data and organizational financial data.

Example 9 is a machine-readable medium, storing instructions for integrating payment card data into a financial treasury management system of an organization, the instructions, which when executed, cause the machine to perform operations comprising: executing one or more data acquisition gatherers to cause receipt of payment card transaction data from one or more external information source components, the payment card transaction data describing a plurality of payment card transactions and tagged with a merchant category code, wherein the payment card transaction data includes, transaction amount, transaction date, transaction time, and location for each transaction described by the payment card transaction data occurred; filtering, at an indicator manager component, the payment card transaction data using the merchant category code tags based upon a merchant category code of the organization; executing second one or more data acquisition gatherers to cause receipt of financial data of the organization from the one or more information source components, the financial data including sales data, location data, and cashflow data; generating a resource optimization recommendation based upon the filtered payment card transaction data and the financial data of the organization as input to a recommendation rule; and responsive to generating the resource optimization recommendation, automatically triggering provisioning of the resource optimization recommendation by transmitting a command to a server over a network.

In Example 10, the subject matter of Example 9 includes, wherein the operations further comprise receiving demographic data associated with the payment card transactions, the demographic data including one or more of age, gender, and income level of cardholders.

In Example 11, the subject matter of Examples 9-10 includes, wherein the operations further comprise: calculating a performance benchmark indicator for the organization by comparing the payment card transaction data with transaction data from other organizations within a same merchant category code; and displaying the performance benchmark indicator to the organization in a UI generated by the financial treasury management system.

In Example 12, the subject matter of Examples 9-11 includes, wherein the operations further comprise generating a predictive indicator describing predicted future sales based on a rule, historical payment card transaction data, and the financial data of the organization.

In Example 13, the subject matter of Examples 9-12 includes, wherein the operations further comprise receiving geographic data associated with the payment card transactions, the geographic data including one or more of city, state, and zip code of transaction locations.

In Example 14, the subject matter of Examples 9-13 includes, wherein the resource optimization recommendation is a resource discount provided by the organization, the resource optimization recommendation targeted to one or more of a specific demographic, a specific time, a specific product, or a specific location.

In Example 15, the subject matter of Examples 9-14 includes, wherein the operations further comprise generating alert indicators for the organization when the payment card transaction data indicates a deviation from expected sales patterns that exceeds a threshold.

In Example 16, the subject matter of Examples 9-15 includes, wherein the resource optimization recommendation is providing a resource lending product based on predicted resource shortages derived from the payment card transaction data and organizational financial data.

Example 17 is a computing device for integrating payment card data into a financial treasury management system of an organization, the computing device comprising: a hardware processor; a memory, the memory storing instructions, which when executed by the hardware processor cause the computing device to perform operations comprising: executing one or more data acquisition gatherers to cause receipt of payment card transaction data from one or more external information source components, the payment card transaction data describing a plurality of payment card transactions and tagged with a merchant category code, wherein the payment card transaction data includes, transaction amount, transaction date, transaction time, and location for each transaction described by the payment card transaction data occurred; filtering, at an indicator manager component, the payment card transaction data using the merchant category code tags based upon a merchant category code of the organization; executing second one or more data acquisition gatherers to cause receipt of financial data of the organization from the one or more information source components, the financial data including sales data, location data, and cashflow data; generating a resource optimization recommendation based upon the filtered payment card transaction data and the financial data of the organization as input to a recommendation rule; and responsive to generating the resource optimization recommendation, automatically triggering provisioning of the resource optimization recommendation by transmitting a command to a server over a network.

In Example 18, the subject matter of Example 17 includes, wherein the operations further comprise receiving demographic data associated with the payment card transactions, the demographic data including one or more of age, gender, and income level of cardholders.

In Example 19, the subject matter of Examples 17-18 includes, wherein the operations further comprise: calculating a performance benchmark indicator for the organization by comparing the payment card transaction data with transaction data from other organizations within a same merchant category code; and displaying the performance benchmark indicator to the organization in a UI generated by the financial treasury management system.

In Example 20, the subject matter of Examples 17-19 includes, wherein the operations further comprise generating a predictive indicator describing predicted future sales based on a rule, historical payment card transaction data, and the financial data of the organization.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

What is claimed is:

1. A computer-implemented method for integrating payment card data into a financial treasury management system of an organization, the method comprising, at the financial treasury management system:
executing one or more data acquisition gatherers to cause receipt of payment card transaction data from one or more external information source components, the payment card transaction data describing a plurality of payment card transactions and tagged with a merchant category code, wherein the payment card transaction data includes transaction amount, transaction date, transaction time, and location for each transaction described by the payment card transaction data occurred;
filtering, at an indicator manager component, the payment card transaction data using the merchant category code tags based upon a merchant category code of the organization;
executing second one or more data acquisition gatherers to cause receipt of financial data of the organization from the one or more information source components, the financial data including sales data, location data, and cashflow data;
generating a resource optimization recommendation based upon the filtered payment card transaction data and the financial data of the organization as input to a recommendation rule; and
responsive to generating the resource optimization recommendation, automatically triggering provisioning of the resource optimization recommendation by transmitting a command to a server over a network.

2. The method of claim 1, further comprising receiving demographic data associated with the payment card transactions, the demographic data including one or more of age, gender, and income level of cardholders.

3. The method of claim 1, further comprising:
calculating a performance benchmark indicator for the organization by comparing the payment card transaction data with transaction data from other organizations within a same merchant category code; and
displaying the performance benchmark indicator to the organization in a UI generated by the financial treasury management system.

4. The method of claim 1, further comprising generating a predictive indicator describing predicted future sales based on a rule, historical payment card transaction data, and the financial data of the organization.

5. The method of claim 1, further comprising receiving geographic data associated with the payment card transactions, the geographic data including one or more of city, state, and zip code of transaction locations.

6. The method of claim 1, wherein the resource optimization recommendation is a resource discount provided by the organization, the resource optimization recommendation targeted to one or more of a specific demographic, a specific time, a specific product, or a specific location.

7. The method of claim 1, further comprising generating alert indicators for the organization when the payment card transaction data indicates a deviation from expected sales patterns that exceeds a threshold.

8. The method of claim 1, wherein the resource optimization recommendation is providing a resource lending product based on predicted resource shortages derived from the payment card transaction data and organizational financial data.

9. A machine-readable medium, storing instructions for integrating payment card data into a financial treasury management system of an organization, the instructions, which when executed, cause the machine to perform operations comprising:
executing one or more data acquisition gatherers to cause receipt of payment card transaction data from one or more external information source components, the payment card transaction data describing a plurality of payment card transactions and tagged with a merchant category code, wherein the payment card transaction data includes transaction amount, transaction date, transaction time, and location for each transaction described by the payment card transaction data occurred;
filtering, at an indicator manager component, the payment card transaction data using the merchant category code tags based upon a merchant category code of the organization; executing second one or more data acquisition gatherers to cause receipt of financial data of the organization from the one or more information source components, the financial data including sales data, location data, and cashflow data;
generating a resource optimization recommendation based upon the filtered payment card transaction data and the financial data of the organization as input to a recommendation rule; and
responsive to generating the resource optimization recommendation, automatically triggering provisioning of the resource optimization recommendation by transmitting a command to a server over a network.

10. The machine-readable medium of claim 9, wherein the operations further comprise receiving demographic data associated with the payment card transactions, the demographic data including one or more of age, gender, and income level of cardholders.

11. The machine-readable medium of claim 9, wherein the operations further comprise:
calculating a performance benchmark indicator for the organization by comparing the payment card transaction data with transaction data from other organizations within a same merchant category code; and
displaying the performance benchmark indicator to the organization in a UI generated by the financial treasury management system.

12. The machine-readable medium of claim 9, wherein the operations further comprise generating a predictive indicator describing predicted future sales based on a rule, historical payment card transaction data, and the financial data of the organization.

13. The machine-readable medium of claim 9, wherein the operations further comprise receiving geographic data associated with the payment card transactions, the geographic data including one or more of city, state, and zip code of transaction locations.

14. The machine-readable medium of claim 9, wherein the resource optimization recommendation is a resource discount provided by the organization, the resource optimization recommendation targeted to one or more of a specific demographic, a specific time, a specific product, or a specific location.

15. The machine-readable medium of claim 9, wherein the operations further comprise generating alert indicators for the organization when the payment card transaction data indicates a deviation from expected sales patterns that exceeds a threshold.

16. The machine-readable medium of claim 9, wherein the resource optimization recommendation is providing a resource lending product based on predicted resource shortages derived from the payment card transaction data and organizational financial data.

17. A computing device for integrating payment card data into a financial treasury management system of an organization, the computing device comprising:
a hardware processor;
a memory, the memory storing instructions, which when executed by the hardware processor cause the computing device to perform operations comprising:
executing one or more data acquisition gatherers to cause receipt of payment card transaction data from one or more external information source components, the payment card transaction data describing a plurality of payment card transactions and tagged with a merchant category code, wherein the payment card transaction data includes transaction amount, transaction date, transaction time, and location for each transaction described by the payment card transaction data occurred;
filtering, at an indicator manager component, the payment card transaction data using the merchant category code tags based upon a merchant category code of the organization; executing second one or more data acquisition gatherers to cause receipt of financial data of the organization from the one or more information source components, the financial data including sales data, location data, and cashflow data;
generating a resource optimization recommendation based upon the filtered payment card transaction data and the financial data of the organization as input to a recommendation rule; and
responsive to generating the resource optimization recommendation, automatically triggering provisioning of the resource optimization recommendation by transmitting a command to a server over a network.

18. The computing device of claim 17, wherein the operations further comprise receiving demographic data associated with the payment card transactions, the demographic data including one or more of age, gender, and income level of cardholders.

19. The computing device of claim 17, wherein the operations further comprise:
calculating a performance benchmark indicator for the organization by comparing the payment card transaction data with transaction data from other organizations within a same merchant category code; and
displaying the performance benchmark indicator to the organization in a UI generated by the financial treasury management system.

20. The computing device of claim 17, wherein the operations further comprise generating a predictive indicator describing predicted future sales based on a rule, historical payment card transaction data, and the financial data of the organization.
